(19) United States
(12) Patent Application Publication
(10) Pub. No.: US 2026/0117857 A1
(43) Pub. Date: Apr. 30, 2026

(54) HOUSING ASSEMBLY WITH IMPROVED OIL CHURNING FUNCTION

(71) Applicant: HYUNDAI MOBIS CO., LTD., Seoul (KR)

(72) Inventors: Dae Wook KIM, Yongin-si (KR); Jin Ho JUNG, Eschborn (DE); SERGII SHAGOVKA, Eschborn (DE)

(73) Assignee: HYUNDAI MOBIS CO., LTD., Seoul (KR)

(21) Appl. No.: 19/335,519

(22) Filed: Sep. 22, 2025

(30) Foreign Application Priority Data
Oct. 29, 2024 (KR) 10-2024-0149402

(51) Int. Cl. F16H 57/04

(52) U.S. Cl. CPC F16H 57/0458; F16H 57/0424

(57) ABSTRACT

The present disclosure relates to a housing assembly applied to an off-axis (lay-shaft) type reducer. The housing assembly with an improved oil churning function to which a plurality of gears of a vehicle reducer are coupled comprises: a cover housing including one surface coupled to a differential gear and a first counter gear, a middle housing including one surface that is coupled to an input gear and a second counter gear coupled to the first counter gear, wherein the one surface is provided to face the one surface of the cover housing, and lower end communicates with a sump space and an oil guide part machined and disposed on the cover housing and the middle housing to guide a flow direction of churned oil.

### CROSS REFERENCE TO RELATED APPLICATION

The present application claims priority to Korean Patent Application No. 10-2024 0149402, filed Oct. 29, 2024, the entire contents of which is incorporated herein for all purposes by this reference.

### BACKGROUND OF THE DISCLOSURE

### Field of the Disclosure

The present disclosure relates to a housing assembly applied to an off-axis (lay-shaft) type reducer.

### Description of the Related Art

An off-axis (lay-shaft) reducer is a type of reducer used in electric motors and is operated by the largest differential gear scooping up oil and supplying the oil to the bearings and gears rather than spraying oil point-by-point to each bearing and gear causing solid-state friction, and a primary area of the oil supply varies depending on an axial location of a differential gear and an angle of a helical gear.

However, in the conventional off-axis (lay-shaft) reducers, since the axial location and helical angle of the differential gear are designed to favor lubrication only within a cover, there is a problem that the main oil flow is formed along an inner surface of the cover, resulting in bearings located in a middle housing not receiving sufficient lubrication. More specifically, in the conventional off-axis (lay-shaft) structure, since the differential gear is provided at a location close to the cover and the helical angle is set to pump oil to the cover, lubricating oil flows directly along an inner surface of the cover housing, and the flow of oil is not changed since no additional rib is provided. Accordingly, lubricating oil is not transferred to the bearings located in the middle housing. In addition, since the inner surface of the cover housing has a gentle oval shape, lubricating oil circulates along the inner surface of the cover housing without any resistance and returns to an oil reservoir at the bottom, and thus there is a problem that the lubricating oil is not transferred to bearings and gears mounted in a central portion of the cover housing.

### DOCUMENTS OF RELATED ART

(Patent Document 1) Korean Laid-Open Patent No. 10-2021-0107406 “GEAR SYSTEM”

### SUMMARY OF THE DISCLOSURE

The present disclosure has been made in efforts to solve the above problems and is directed to providing a housing assembly with an improved oil churning function, which can improve lubrication performance and cooling performance by improving shapes of an outer surface and inner surface of a cover housing and a middle housing so that lubricating oil is supplied evenly to each bearing and gear during oil churning.

According to one embodiment of the present disclosure, there is provided a housing assembly with an improved oil churning function to which a plurality of gears of a vehicle reducer are coupled, including a cover housing whose one surface is coupled to a differential gear and a first counter gear, a middle housing whose one surface is coupled to an input gear and a second counter gear coupled to the first counter gear, one surface is provided to face one surface of the cover housing, and lower end communicates with a sump space, and an oil guide part machined and formed on the cover housing and the middle housing to guide a flow direction of churned oil.

In addition, the oil guide part may include a guide groove formed to a predetermined depth in an outer edge of the cover housing.

In addition, the guide groove may be formed on an edge of the cover housing corresponding to an upper side of the first counter gear.

In addition, the guide groove may be formed in a streamlined shape with a curvature greater than or equal to a predetermined value.

In addition, the oil guide part may further include a first guide rib formed to protrude a predetermined height from the one surface of the cover housing and formed to extend inward from one end of the guide groove.

In addition, the first guide rib may be formed to be inclined at a predetermined angle in a direction perpendicular to the ground.

In addition, the oil guide part may include a second guide rib formed to protrude from the one surface of the middle housing and formed at a location corresponding to the first guide rib, and the second guide rib may be in contact with the first guide rib to allow oil to be transferred from the first guide rib to the second guide rib.

In addition, the oil guide part may further include a third guide rib formed to protrude a predetermined height from the one surface of the cover housing and formed to extend from the other end of the guide groove to a center of the first counter gear.

In addition, the middle housing may include a gear case part concavely formed at a location corresponding to the differential gear, and the oil guide part may further include a fourth guide rib formed to protrude a predetermined height from an inner surface of the gear case part and formed to extend from an edge of the inner surface toward a center of the differential gear.

In addition, the fourth guide rib may be formed to be inclined at a predetermined angle in a direction perpendicular to the ground.

### BRIEF DESCRIPTION OF THE DRAWINGS

FIG. 1 is a partial cross-sectional view showing a housing assembly with an improved oil churning function of the present disclosure.

FIG. 2 is a plan view showing an inner surface of a cover housing of the present disclosure.

FIG. 3 is a partial plan view showing the inner surface of the cover housing of the present disclosure.

FIG. 4 is a plan view showing an inner surface of a middle housing of the present disclosure.

FIG. 5 is a partial plan view showing the inner surface of the middle housing of the present disclosure.

### DETAILED DESCRIPTION OF THE DISCLOSURE

Hereinafter, the technical spirit of the present disclosure will be described in more detail with reference to the accompanying drawings. Prior to the description, terms or words used in the present specification and claims should not be construed as limited to their usual or dictionary meanings and should be construed as meanings and concepts that conform to the technical idea of the present disclosure based on the principle that the inventor can appropriately define the concepts of the terms in order to describe his or her own Disclosure in the best mode.

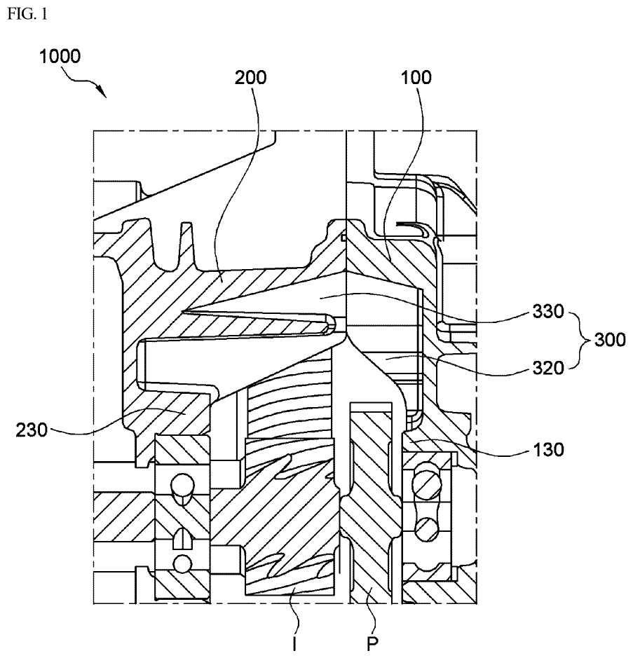

Hereinafter, a basic configuration of a housing assembly 1000 with an improved oil churning function of the present disclosure will be described with reference to FIG. 1.

The housing assembly 1000 with an improved oil churning function of the present disclosure may serve to support multiple gears of an off-axis (lay-shaft) type vehicle reducer, with each gear coupled thereto, and include a cover housing 100 and a middle housing 200. The cover housing 100 and the middle housing 200 may each be coupled to gears included in the off-axis (lay-shaft) type vehicle reducer so that their locations may be supported. The cover housing 100 and the middle housing 200 may be provided so that one surfaces face each other to form a space therein. In particular, the middle housing 200 may have a lower end communicating with a sump space to allow lubricating oil to be supplied into the space formed by the cover housing 100 and the middle housing 200.

In addition, the housing assembly 1000 with an improved oil churning function of the present disclosure may include an oil guide part 300 machined and formed on the cover housing 100 and the middle housing 200 to guide a flow direction of the churned oil. By including the oil guide part 300, the lubricating oil not only flows along an inner surface of any one of the cover housing 100 or the middle housing 200, but also is evenly distributed within the space formed by the cover housing 100 and the middle housing 200, that is, a space in which the gears and bearings of the reducer are provided, thereby maximizing the lubrication performance and cooling performance of the reducer.

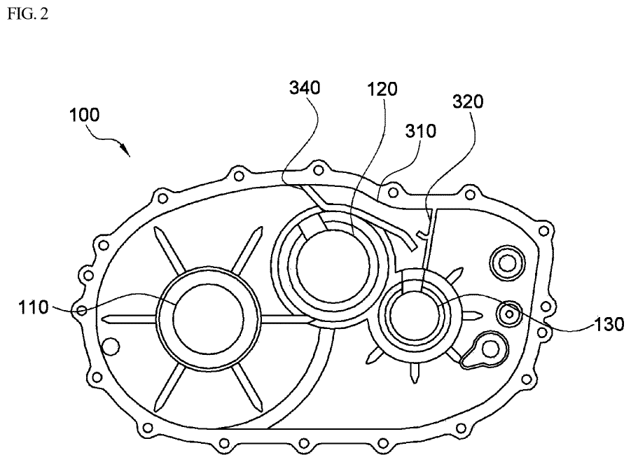

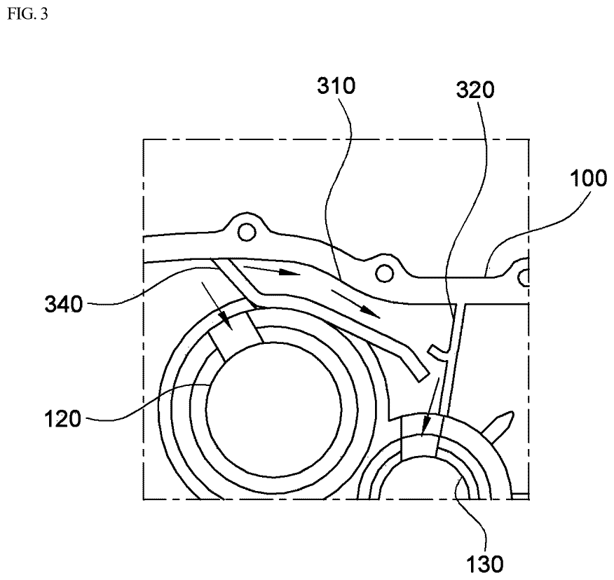

Hereinafter, the specific shape of the oil guide part 300 applied to the cover housing 100 of the present disclosure will be described in more detail with reference to FIGS. 2 and 3.

As shown in FIG. 2, the cover housing 100 may have one surface coupled to a differential gear, a first counter gear, and a parking gear P. More specifically, the cover housing 100 may have a differential gear coupling part 110, a first counter gear coupling part 120, and a parking gear coupling part 130 formed on one surface, to which a differential gear, a first counter gear, and a parking gear P and their related bearings are coupled, respectively.

In this case, the oil guide part 300 may include a guide groove 310 formed to a predetermined depth in an outer edge of the cover housing 100. By including the guide groove 310, an inner surface of the cover housing 100 may be formed in a distorted shape rather than an oval, thereby allowing lubricating and cooling oil to be supplied into the cover housing 100. In addition, the oil guide part 300 may further include a first guide rib 320 formed to protrude a predetermined height from one surface of the cover housing 100 and formed to extend inward from one end of the guide groove 310. By including the first guide rib 320, the flow of oil flowing along an inner edge of the cover housing 100 can be interrupted once, and then supplied to the gears and bearings inside the cover housing 100 along the first guide rib 320.

More specifically, as shown in FIG. 3, the guide groove 310 may be formed on the edge of the cover housing 100 corresponding to an upper side of a first counter gear. Accordingly, lubricating oil may flow to the first counter gear located at the central portion of the cover housing 100 and may also be transferred to the differential gear and the parking gear P adjacent to the first counter gear. The guide groove 310 may be formed in a streamlined shape with a curvature greater than or equal to a predetermined value to naturally guide the lubricating oil inward from the cover housing 100.

In addition, the first guide rib 320 may be formed to be inclined at a predetermined angle in a direction perpendicular to the ground. More specifically, the first guide rib 320 may be formed in a direction of the about 1 to 2 o'clock with respect to a phase mounted in the vehicle. Accordingly, some oil may flow into an inner ring of the bearing supporting the gear to perform a lubricating function, and most of the oil may flow through the differential gear coupling part 110, the first counter gear coupling part 120, and the parking gear coupling part 130 into which the bearing is press-fitted to perform a cooling function.

In addition, the oil guide part 300 may further include a third guide rib 340 formed to protrude a predetermined height from one surface of the cover housing 100 and formed to extend from the other end of the guide groove 310 toward the center of the first counter gear. By including the third guide rib 340, the lubricating and cooling oil can be more effectively concentrated on the inner, that is, the central, area of the cover housing 100. In addition, the third guide rib 340 may be formed at a lower height than the first guide rib 320 and formed to be inclined at a predetermined angle in the direction perpendicular to the ground, but may be formed to be inclined in a direction opposite to the first guide rib 320. More specifically, the third guide rib 340 may be formed in a direction of about 9 to 11 o'clock with respect to the phase mounted in the vehicle. Accordingly, some oil may flow into an inner ring of the bearing supporting the gear to perform a lubricating function, and most of the oil may flow through the differential gear coupling part 110, the first counter gear coupling part 120, and the parking gear coupling part 130 into which the bearing is press-fitted to perform a cooling function.

In addition, when both the first guide rib 320 and the third guide rib 340 are formed, the lubricating and cooling oil may be sprayed from both sides of the first counter gear along the first guide rib 320 and the third guide rib 340, thereby more effectively cooling the first counter gear and ensuring that the lubricating and cooling oil is smoothly supplied to the differential gear and the parking gear P provided on both sides of the first counter gear.

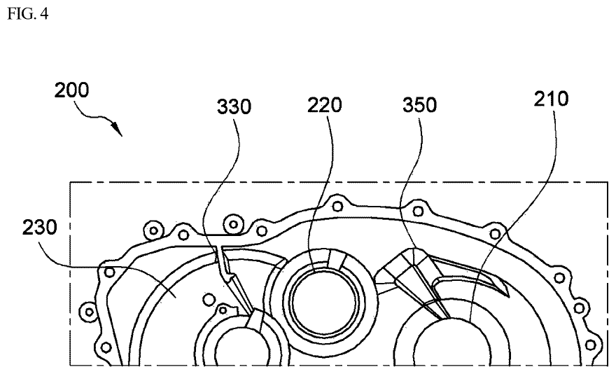

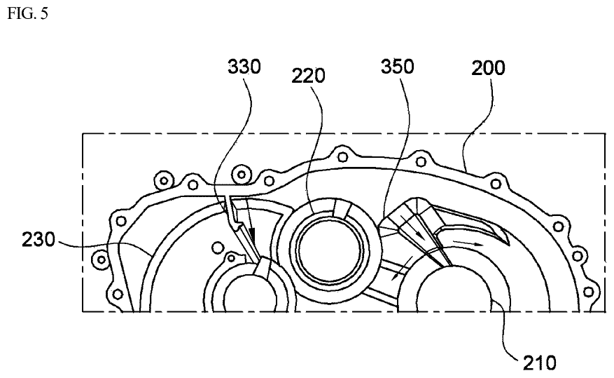

Hereinafter, the specific shape of the oil guide part 300 applied to the middle housing 200 of the present disclosure will be described in more detail with reference to FIGS. 4 and 5.

As shown in FIG. 4, the middle housing 200 may have one surface coupled to an input gear I and a second counter gear connected to the first counter gear, one surface facing one surface of the cover housing, and a lower end communicating with the sump space. The middle housing 200 may have one surface formed with a gear case part 210 that is concavely formed at a location corresponding to the differential gear and accommodates the differential gear and one surface formed with a second counter gear coupling part 220 and an input gear coupling part 230 to which the second counter gear and the input gear I and the related bearings are coupled, respectively.

In this case, the oil guide part 300 may include a second guide rib 330 formed to protrude from one surface of the middle housing 200 and formed at a location corresponding to the first guide rib 320 and at the input gear coupling part 230. In this case, the protruding surfaces of the first guide rib 320 and the second guide rib 330 may be in contact with each other. Accordingly, the lubricating and cooling oil flowing along the inner surface of the cover housing 100 may flow to the inner surfaces of the second guide rib 330 and the middle housing 200 through the first guide rib 320. Accordingly, the lubricating and cooling oil may also be supplied to the gears and bearings coupled to the middle housing 200.

In addition, the middle housing 200 preferably includes the gear case part 210 that is concavely formed at a location corresponding to the differential gear, and the oil guide part 300 preferably further includes a fourth guide rib 350 formed to protrude a predetermined height from an inner surface of the gear case part 210 to a predetermined height and formed to extend from an edge of the inner surface toward the center of the differential gear. By forming the fourth guide rib 350 in the gear case part 210, oil churned by the differential gear in the sump space can be prevented from falling directly into the sump space by being blocked by the fourth guide rib 350, thereby improving the lubrication performance and cooling performance for other gears and bearings.

In addition, the second guide rib 330 or the fourth guide rib 350 is preferably formed to be inclined at a predetermined angle in the direction perpendicular to the ground. More specifically, the second guide rib may be formed in a direction of about 1 to 2 o'clock or 10 to 11 o'clock with respect to the phase mounted in the vehicle. Accordingly, as shown in FIG. 5, some oil may flow to the inner ring of the bearing supporting the differential gear to perform a lubricating function, and most of the oil may flow along the inner surface of the gear case part 210 to perform a cooling function for the differential gear and bearing.

According to the housing assembly with an improved oil churning function of the present disclosure having the above configuration, it is possible to improve lubrication performance and cooling performance by improving shapes of an outer surface and inner surface of a cover housing and a middle housing so that lubricating oil is supplied evenly to each bearing and gear during oil churning.

The technical spirit of the present disclosure should not be construed as limited to the above-described embodiments. Not only the scope of applications is diverse, but also various modifications may be made by those skilled in the art without departing from the gist of the present disclosure as claimed in the claims. Accordingly, these improvements and changes fall within the scope of the present disclosure as long as they are obvious to those skilled in the art.

What is claimed is:

1. A housing assembly with an improved oil churning function to which a plurality of gears of a vehicle reducer are coupled, the housing assembly comprises:
a cover housing including one surface coupled to a differential gear and a first counter gear;
a middle housing including one surface that is coupled to an input gear and a second counter gear coupled to the first counter gear, wherein the one surface is provided to face the one surface of the cover housing, and lower end communicates with a sump space; and
an oil guide part machined and disposed on the cover housing and the middle housing to guide a flow direction of churned oil.

2. The housing assembly of claim 1, wherein the oil guide part includes a guide groove formed to a predetermined depth in an outer edge of the cover housing.

3. The housing assembly of claim 2, wherein the guide groove is disposed on an edge of the cover housing corresponding to an upper side of the first counter gear.

4. The housing assembly of claim 2, wherein the guide groove is disposed in a streamlined shape with a curvature greater than or equal to a predetermined value.

5. The housing assembly of claim 2, wherein the oil guide part further includes a first guide rib formed to protrude a predetermined height from the one surface of the cover housing and formed to extend inward from one end of the guide groove.

6. The housing assembly of claim 5, wherein the first guide rib is formed to be inclined at a predetermined angle in a direction perpendicular to a ground.

7. The housing assembly of claim 5, wherein the oil guide part includes a second guide rib formed to protrude from the one surface of the middle housing and disposed at a location corresponding to the first guide rib, and
the second guide rib is in contact with the first guide rib to allow oil to be transferred from the first guide rib to the second guide rib.

8. The housing assembly of claim 2, wherein the oil guide part further includes a third guide rib formed to protrude a predetermined height from the one surface of the cover housing and formed to extend from the other end of the guide groove to a center of the first counter gear.

9. The housing assembly of claim 1, wherein the middle housing includes a gear case part concavely formed at a location corresponding to the differential gear, and
the oil guide part further includes a fourth guide rib formed to protrude a predetermined height from an inner surface of the gear case part and formed to extend from an edge of the inner surface toward a center of the differential gear.

10. The housing assembly of claim 9, wherein the fourth guide rib is formed to be inclined at a predetermined angle in a direction perpendicular to a ground.
